(19) United States
(12) Patent Application Publication
(10) Pub. No.: US 2015/0140469 A1
(43) Pub. Date: May 21, 2015

(54) COMPARTMENTLESS ABIOTIC SUCROSE-AIR FUEL CELL

(71) Applicant: SNU R&DB FOUNDATION, Seoul (KR)

(72) Inventors: Taek Dong Chung, Gwacheon-si (KR); Ji Hyung Han, Jeju-si (KR)

(21) Appl. No.: 14/598,527

(22) Filed: Jan. 16, 2015

Related U.S. Application Data
(63) Continuation-in-part of application No. PCT/KR2013/000138, filed on Jan. 8, 2013.

(30) Foreign Application Priority Data
Jul. 16, 2012 (KR) 10-2012-0077483

(51) Int. Cl. H01M 4/86; H01M 8/10; H01M 4/92

(52) U.S. Cl. CPC H01M 4/8621; H01M 4/925; H01M 8/1013; H01M 8/1018; H01M 2008/1095; H01M 2250/30; H01M 2300/0082
USPC 429/480; 429/485; 429/487

(57) ABSTRACT

The present invention provides a fuel electrode including a substrate and a nanoporous metallic catalyst layer, characterized in that the metallic catalyst layer includes open interconnected 3D nanopores, and the pore and the pore connections have a size suitable for allowing hydrocarbons having alcohol groups to pass through the interconnected pores so that they react in contact with the surface of the catalyst by confined molecular dynamics. Further, the present invention provides a compartmentless fuel cell electrode pair including the fuel electrode of the present invention; and a polymer membrane-coated oxygen electrode into which a catalyst layer is introduced onto the substrate and which blocks the hydrocarbons having alcohol groups as a fuel molecule and allows the diffusion of oxygen molecules. Furthermore, the present invention provides an abiotic saccharide-air fuel cell including the fuel electrode of the present invention, the oxygen electrode to which a nonconducting polymer membrane is applied, and a container capable of containing hydrocarbons having alcohol groups, in which the fuel cell utilizes the hydrocarbons having alcohol groups as a fuel.

### BACKGROUND OF THE INVENTION

1. Field of the Invention

The present invention relates to a fuel electrode; a compartmentless fuel cell electrode pair including the fuel electrode and an oxygen electrode; and an abiotic saccharide-air fuel cell including the electrode pair.

2. Description of the Related Art

Carbohydrates have been emerging as promising fuels for the future energy industry because they possess high energy density and a tremendous amount of carbohydrates can be obtained from the abundant biomass. Sucrose is a representative disaccharide that is mass-produced from sugar cane or sugar beet supplied from over 100 countries around the world. In our daily lives, it can be provided from foods such as carbonated drinks and juices. Sugars such as sucrose can be converted into ethanol or hydrogen, and direct electrochemical oxidation of sucrose to generate electricity is a potentially competitive approach in terms of the demand for a small, handy, and cost-effective electric power source.

There are reports that a sucrose fuel cell can produce a relatively high power density through metabolic or enzymatic activity of microorganisms. However, it has hardly been used, compared to the glucose fuel cell which has been proposed for supply of electrical power to implantable electronic appliances for decades. The fuel cells based on metabolic or enzymatic activity of microorganisms are vulnerable to stability problems due to biological units being integrated in the electrochemical device. Further, tricky operating conditions such as temperature, growth medium, mediator, etc. are serious technical obstacles to the miniaturization of portable electricity generator systems.

Another strategy for using carbohydrates including saccharides as a fuel source is to exploit electrocatalytic ability of metallic catalysts such as platinum, palladium, ruthenium, gold, nickel, non-noble metal, etc. or activated carbons unaided by biological functionality. These catalysts and electrolytes are used in various combinations to constitute a sucrose fuel cell which is operated by an electrode reaction with sufficient efficiency. Furthermore, a small simple fuel cell system which is manufactured by integrating a plurality of unit cells and does not require a mediator or any other components, has higher power density. Electrocatalytic ability of Electrodes in an enzymeless fuel cell can be easily regenerated by electrochemical or chemical cleaning, unlike enzyme-immobilized electrodes. Despite the potential availability, there have been no reports about direct sucrose fuel cells based on abiotic catalysts, until now.

### SUMMARY OF THE INVENTION

Accordingly, the present inventors have made extensive efforts to develop a portable abiotic fuel cell which can be operated by using readily available carbohydrates having alcohol groups, for example, saccharides such as monosaccharides, disaccharides, etc., as a fuel source. They found that the kinetics of sucrose electro-oxidation is too slow to observe faradaic current at a flat platinum electrode, and thus they introduced a nanoporous electrode capable of non-enzymatic disaccharide oxidation. The nanoporous electrode has a very high surface area-volume ratio and unique molecular dynamics in a nanoporous structure providing dominant electrocatalytic activity. Further, they designed that selective diffusion of oxygen molecules can be allowed without an electrolyte membrane by electrochemically coating a cathode with a polymer membrane, and thus both electrodes can be placed in a single compartment so as to manufacture a compartmentless abiotic saccharide-air fuel cell with a reduced volume, thereby completing the present invention.

In one aspect, the present invention provides a fuel electrode including a substrate and a nanoporous metallic catalyst layer, characterized in that the metallic catalyst layer includes open interconnected 3D nanopores, and the pores and the pore connections therebetween have the size suitable for allowing hydrocarbons having alcohol groups to pass through the interconnected pores so that they react in contact with the surface of the catalyst.

In another aspect, the present invention provides a compartmentless fuel cell electrode pair including the fuel electrode; and a polymer membrane-coated oxygen electrode into which a catalyst layer is introduced onto the substrate and wherein the polymer membrane blocks the hydrocarbons having alcohol groups as a fuel molecule and permits the diffusion of oxygen molecules.

In still another aspect, the present invention provides an abiotic saccharide-air fuel cell including the fuel electrode, the oxygen electrode to which a nonconducting polymer membrane is applied, and a container capable of containing hydrocarbons having alcohol groups, in which the fuel cell utilizes the hydrocarbons having alcohol groups as fuels.

### BRIEF DESCRIPTION OF THE DRAWINGS

FIG. 1 is a schematic diagram showing an abiotic sucrose-air fuel cell using nanoporous platinum (L₂-ePt);

FIG. 2 is a diagram showing fabrication of an L₂-ePt electrode, in which the distance between the pores is 1 to 2 nm, and the size of a Pt nanoparticle is approximately 3 nm;

FIG. 3 shows a cyclic voltammogram of an L₂-ePt (R_{f} 240) electrode in 100 mM KOH containing 20 mM sucrose at 10 mV;

FIG. 4 shows cyclic voltammograms of a flat platinum electrode (R_{f} 1.9) in 100 mM KOH containing 20 mM sucrose (A) or 20 mM glucose (B) at 10 mV/s;

FIG. 5 shows the mechanism of glucose electro-oxidation;

FIG. 6 shows a cyclic voltammogram of the L₂-ePt (R_{f} 240) electrode in 100 mM KOH solutions containing various saccharides at a concentration of 20 mM during potential sweeping at a rate of 10 mV/s;

FIG. 7 shows the result of cyclic voltammetry of the L₂-ePt (R_{f} 240) electrode in 100 mM KOH solutions containing sucrose at various concentrations, of which (A) shows a cyclic voltammogram during potential sweeping at a rate of 10 mV/s; and (B) shows a log scale for the relationship between oxidation current density and sucrose concentration, and the slope of Peak 3 is similar to that of Peak 2 (data is not shown);

FIG. 8 shows a cyclic voltammogram of the L₂-ePt (R_{f} 240) electrode in 100 mM KOH solution containing 20 mM sucrose at various potential sweep rates;

FIG. 9 shows a plot of oxidation current density versus glucose concentration on the L₂-ePt (R_{f} 240) electrode, in which the slope of Peak 3 is similar to that of Peak 2 (data is not shown);

FIG. 10 shows a plot of oxidation current density versus glucose concentration on a flat Pt (Rf 1.9) electrode, in which it was difficult to distinguish Peak 1 from Peak 2 at the flat Pt electrode, and thus current density in the electric double layer (EDL) region measured at −0.25 V was shown;

FIG. 11 shows cyclic voltammograms of the flat Pt (R_{f} 1.9; A) electrode and the L₂-ePt (R_{f} 240; B) electrode in a 1M sulfuric acid solution during potential sweeping at a rate of 200 mV/s;

FIG. 12 shows cyclic voltammograms of the flat Pt (R_{f} 1.9) electrode and the L₂-ePt (R₁ 240) electrode in a 100 mM KOH solution containing saccharides during potential sweeping at a rate of 10 mV/s, in which (A) shows the result of 20 mM sucrose solution, and (B) shows the result of glucose solution at the same concentration, and current density value was obtained by dividing the current by real surface area, instead of by apparent surface area;

FIG. 13 shows the result of linear sweep voltammetry (LSV), in which (A) is the result obtained from air-saturated 100 mM KOH solution on flat platinum (R_{f} 1.9) and L₂-ePt (R_{f} 240) electrode during potential sweeping at a rate of 10 mV/s, (B) is a cyclic voltammogram for sucrose oxidation in the presence or absence of poly-m-PD membrane on the L₂-ePt (R_{f} 200) electrode in a 100 mM KOH solution containing 20 mM sucrose during potential sweeping at a rate of 10 mV/s;

FIG. 14 shows a line sweep voltammogram of the L₂-ePt (R_{f} 220) electrode for oxygen reduction of a 100 mM KOH solution during potential sweeping at a rate of 10 mV/s, in which pretreatment was performed using a sulfuric acid solution with 5 repetitions of potential sweep cycling at a rate of 200 mV/s for optimization;

FIG. 15 shows polarization and a voltage-density curve of the sucrose-air fuel cell using the L₂-ePt electrode for KOH exposed to air at room temperature and various concentrations of sucrose, in which open circle/square/triangle represent output voltage under the corresponding conditions, respectively and the solid circle/square/triangle represent power density;

FIG. 16 shows the long-term stability at room temperature of the abiotic sucrose-air fuel cell using L₂-ePt electrode of 5 μA/cm² in 20 mM sucrose/100 mM KOH solution;

FIG. 17 shows polarization and voltage density of 1/10-diluted coke for the sucrose-air fuel cell using the L₂-ePt electrode in air containing 100 mM KOH at room temperature, in which open and solid circles represent output voltage and power density, respectively; and

FIG. 18 shows the number of moles of sucrose reacted during electrolysis, which was examined by peak reduction.

### DETAILED DESCRIPTION OF THE PREFERRED EMBODIMENTS

A fuel cell is an energy conversion device in which chemical energy is directly converted to electrical energy. That is, it is an energy conversion device distinguished from an energy storage device. The fuel cell has a broad range of applications from an auxiliary power source of automobiles, trucks, aircrafts, etc. to electric power for portable computers, PDAs, cell phones, and digital home appliances. Furthermore, demand for a small light battery is rapidly growing with generalization of portable computers, cell phones, etc. in modern society. This fuel cell is advantageous in that energy consumption can be reduced by improvement of energy efficiency, and consumption of fossil fuels can also be reduced to reduce global warming and to improve the atmospheric environment. Unlike conventional batteries, the fuel cell continues to produce electricity as long as it is supplied with external fuel and air.

Generally, the fuel cell includes a cathode (i.e., oxygen electrode), anode (i.e., fuel electrode) and electrolyte. Structurally, the cathode and the anode are separated from each other by an electrolyte membrane. Thus, oxidation of the fuel material occurs at the anode, and reduction of oxygen occurs at the cathode. It is possible to constitute fuel cells with varying capacities, because they can readily be enlarged by modulation and stacking. However, presence of the electrolyte membrane is a barrier to miniaturization of the fuel cell. Another barrier to portability is stability of fuels. There have been studies on a direct fuel cell using methanol as a fuel, but the studies are delayed due to safety regulations that prohibit the carrying of methanol on aircraft. Therefore, development of safety-assured fuels is another task in the development of portable fuel cells.

In general, disaccharides require a high potential for oxidation, compared to monosaccharides. For this reason, reactivity was increased by improving electrodes, catalysts, etc. in an enzymeless fuel cell for the development of a fuel cell using monosaccharide as a fuel, but there have been no reports about abiotic fuel cells using disaccharides as a fuel.

In the present invention, the reaction area of the electrode was remarkably increased by using an electrode having a nanoporous catalyst layer as a fuel electrode. The nanoporous catalyst layer has open nanopores which are three-dimensionally interconnected with each other by pore connections.

As used herein, the “open interconnected 3D nanopores” means a structure in which nanometer-sized pores are distributed on the surface of the catalyst layer, the pores are interconnected with each other inside the catalyst layer by a pore connection, a fuel molecule introduced into one pore moves through the pore connections to cause catalytic reaction, and reaction products from the catalytic reaction and residual fuel molecules continue to move and/or are released from the same fuel molecule-introduced pore or another pore on the surface of the catalyst layer.

In particular, the pore and the pore connections of the nanoporous metallic catalyst of the present invention may have a cross-sectional diameter of 1 to 3 nm, which is comparable to the thickness of electric double layer (EDL). Therefore, an electrochemically effective surface area approaching the theoretical limit can be provided. For example, if the pore and the pore connections have a cross-sectional diameter of <1 nm, an electric double layer may overlap. Therefore, the enlarged surface area provided by the porous structure cannot be used as 100% an electrochemically active area. Meanwhile, if they have a diameter of >3 nm, a rate of increase of the surface area is reduced. Therefore, to prevent overlapping of electric double layer and to maximize the surface area, it is preferable that the pore and the pore connections have a cross-sectional diameter of 1 nm to 3 nm.

Further, the electrode including the nanoporous metallic catalyst layer of the present invention can do more than increase activity due to enlarged surface area. A sucrose molecule exemplified as a disaccharide fuel molecule of the present invention has a bulky crystal size in which the longest axis is 1.086 nm and the shortest axis is 0.776 nm. Compared to the cross-sectional diameter of the nanopore and the pore connections of the metallic catalyst layer of the present invention, the pore size of 1 to 3 nm corresponds to 92 to 276% of the longest axis, and 129% to 386% of the shortest axis of the sucrose molecule. This means bulky sucrose molecule continues to collide with the catalyst surface by confined molecular dynamics when the sucrose molecule introduced into the metallic catalyst layer through the nanopore moves through the pore connections. More frequent interactions obviously lead to higher number of successful electron transfer events per unit period, compared to a flat electrode with the same electroactive surface area. Therefore, when a transition metal having a relatively low catalytic activity, such as nickel, copper, iron, etc., is prepared in the form of the nanoporous structure, high catalytic activity can be expected due to continuous interaction inside nanopores. Further, because the pores are open, the reaction products can continuously diffuse out to the bulk solution and new fuel molecules can be introduced thereto. Therefore, the fuel electrode including the nanoporous metallic catalyst layer of the present invention can be expected to continue to show electrocatalytic activity as long as it is supplied with fuel molecules.

The nanoporous metallic catalyst layer is introduced onto the substrate. The substrate functions as an electrode as well as a support of the catalyst layer. As the substrate, a gold or platinum-plated silicon wafer, a gold or platinum-plated glass slide, a gold or platinum-sputtered polyimide film, an ITO electrode, etc. may be used, but is not limited thereto. It may be in the form of a single-side- or double-side-plated flat, or partially or fully plated rod without limitation, as long as it functions as a support and an electrode.

The metallic catalyst layer of the present invention may be composed of platinum, palladium, ruthenium, porous carbon, etc., but the metallic catalyst layer may include any substance without limitation as long as it has an activity capable of oxidizing saccharides, in particular, disaccharide molecules and alcohol groups, as it is or by introduction of the nanoporous structure of the present invention, unaided by enzymes. An inexpensive transition metal having the nanoporous structure is preferred. Platinum as it is, has high catalytic activity in oxidation-reduction reactions. It is a material that is widely used as an electrode. As such, platinum has activity as an electrode, that is, conductivity, and therefore, it functions to transfer electrons generated by catalytic reaction of the fuel molecule on the catalyst surface to the electrode.

The fuel electrode of the present invention is able to use hydrocarbon having an alcohol group as a fuel. The hydrocarbon having an alcohol group of the present invention may have a molecular weight ranging from 20 to 200, but is not limited thereto. The hydrocarbon having an alcohol group may be a saccharide, and the saccharide may be a monosaccharide, a disaccharide, or a polysaccharide. More preferably, it may be glucose, fructose, or sucrose. Further, the saccharides may be saccharides produced naturally or via an artificial photosynthetic system. The electrode of the present invention may use hydrocarbon having an alcohol group (—OH group) which can be electrochemically oxidized, as a fuel. It may use a substance having an alcohol group with a higher molecular weight (pentanol, glycerol, xylitol, etc.) as well as methanol, ethanol, or propanol with a low molecular weight to obtain energy by the effect of nanopores. That is, as described above, while hydrocarbon having an alcohol group passes through the pore of the nanoporous metallic catalyst layer of the fuel electrode, it reacts in contact with the surface of the catalyst to provide electrons by oxidation, thereby generating electrical energy. The electrons generated by fuel oxidation on the surface of the catalyst are transported to the electrode through the conductive catalyst layer, and thereby making electrical energy available.

According to the specific embodiment of the present invention, the fuel electrode including the nanoporous metallic catalyst layer of the present invention, showed electrode activity capable of oxidizing sucrose having a relatively high oxidation potential. Therefore, it is apparent that saccharides similar to sucrose and hydrocarbons having an alcohol group can be used as fuels.

An oxygen electrode manufactured by applying a polymer membrane onto the catalyst layer of the electrode which is manufactured by introducing the catalyst layer onto the substrate can be used together with the fuel electrode, which is an electrode pair used for a fuel cell.

The polymer membrane applied onto the catalyst layer can be introduced in order to block movement of the fuel molecule, hydrocarbon having an alcohol group by size exclusion and to permit selective diffusion of oxygen molecules. The “selective diffusion of oxygen molecules” means that the polymer membrane applied onto the cathode has smaller pores than the hydrocarbon molecule having an alcohol group such as sucrose used as the fuel in the present invention, and thus small oxygen molecules in the fuel solution pass through the polymer membrane by diffusion, thereby being reduced in contact with the cathode, but the fuel sucrose molecules do not reach the cathode through the polymer membrane.

In general, a fuel cell can be equipped with an electrolyte membrane in order to separate the anode and the cathode, that is, in order to block access of the fuel molecule to the cathode by preventing incorporation of the fuel. Two compartments are formed by the electrolyte membrane, and the anode and the cathode are separately placed in each compartment. At this time, one compartment including the anode, namely, the fuel electrode is filled with a fuel solution, and the other compartment including the cathode, namely, the oxygen electrode is filled with an electrolyte solution which is provided with gas such as air or oxygen. However, the oxygen electrode introduced with the polymer membrane of the present invention is able to permit selective diffusion of oxygen by size exclusion and to block access of the fuel molecule, and thus it does not require an additional electrolyte membrane. Furthermore, it is not necessary to place the fuel electrode and the oxygen electrode in separate compartments.

The non-conducting polymer membrane which can be introduced onto the catalyst layer for selective diffusion of the oxygen molecule may be produced using a material such as poly m-phenylenediamine, polyphenol, etc., but is not limited thereto. Any material may be used without limitation, as long as it prevents diffusion of the fuel and induces selective diffusion of oxygen molecules.

The catalyst layer may be formed using a material such as platinum, palladium, ruthenium, porous carbon, etc., as used in the fuel electrode, but is not limited thereto. Preferably, the catalyst layer may be a nanoporous platinum layer.

Preferably, the fuel cell electrode pair of the present invention can be provided in electrically separated form by arranging the fuel electrode and the oxygen electrode of the present invention at a distance from each other, or by placing a Non-conducting thin spacer between the substrate sides of both electrodes to form an assembly. As described above, the oxygen electrode of the fuel cell electrode pair of the present invention is coated with the polymer membrane to permit selective diffusion of oxygen molecule, and therefore, it is not necessary to separate the fuel electrode therefrom using an additional compartment. Furthermore, the polymer membrane coated on the oxygen electrode is non-conductive, and thus occurrence of undesirable short circuit due to electrical contact between both electrodes can be remarkably reduced. That is, electrical energy loss, damage to the fuel cell and/or malfunction which can be caused by short circuit due to the electrical contact between both electrodes can be blocked. Therefore, as long as the oxygen electrode is favorably supplied with oxygen molecules, it is not necessary to spatially separate the fuel electrode from the oxygen electrode, or the fuel cell can be manufactured by placing a Non-conducting thin spacer between both electrodes substrate sides of which face each other, so that they are electrically separated. Therefore, the volume of the fuel cell can be remarkably reduced.

The fuel cell of the present invention may include a container capable of containing hydrocarbons having alcohol groups as a fuel. The fuel cell uses saccharide solutions or saccharides produced in an artificial photosynthetic system as a fuel, and it may produce energy by direct oxidation thereof. Further, a hybrid system combined with the artificial photosynthetic-saccharide air fuel cell is also expected. The saccharide solution may be prepared by dissolving saccharides in a solvent, but is not limited thereto. It includes all of the saccharide molecules which exist in dissolved form contained in water, and includes beverages such as juice, coke, etc., and fruit juice. There is no limitation as the type of container usable, as long as both the fuel electrode and the oxygen electrode are applied thereto. The container may be manufactured to include the electrodes, or the saccharide solution may be put in a typical container and then the electrodes may be applied thereto. Further, it may include a beverage container, etc. Meanwhile, if fruit juice is used as a fuel, a solid fruit is used as the container and the electrodes are fixed in the fruit, which can be used as a battery. Therefore, no additional container is needed.

Hereinafter, the present invention will be described in more detail with reference to Examples. However, these Examples are for illustrative purposes only, and the invention is not intended to be limited by these Examples.

### Example 1

### Reagent and Instrument

All chemicals including hydrogen hexachloroplatinate hydrate, triton X-100, sulfuric acid, sodium chloride, potassium hydroxide, glucose, fructose, sucrose, m-phenylenediamine (m-PD), and platinum wire (Pt wire) were purchased from Aldrich, and used without an additional purification process. Phosphate buffered saline (PBS) was prepared by mixing 0.1 M H₃PO₄ and 0.1 M Na₃PO₄ containing 0.15 M NaCl. All electrochemical experiments were performed at room temperature.

An electrochemical analyzer (model CH440a, CH Instruments Inc.) was used to perform cyclic voltammetry (CV), linear sweep voltammetry (LSV), and cell potential measurements. Hg/Hg₂SO₄ (saturated K₂SO₄, CH Instruments Inc.) and Ag/AgCl (saturated KCl) were used as a reference electrode for CV and m-PD polymerization in sulfuric acid, respectively. A Pt thin film (2 cm²) was used as a counter electrode. Au sputtered Si wafer electrode (0.25 cm²) was used as a substrate electrode for L₂-ePt deposition.

### Example 2

### Fabrication and Modification of L₂-ePt Electrode

5% by weight of hydrogen hexachloroplatinate hydrate, 45% by weight of 0.3 M NaCl and 50% by weight of triton X-100 were mixed and heated at 60° C. The prepared mixture was transparent and homogeneous. The temperature of the mixture was maintained at 40° C. using a thermostat, and L₂-ePt was electrochemically deposited on the Au sputtered Si wafer electrode (0.25 cm²) by applying −0.2 V versus Ag/AgCl. The fabricated L₂-ePt electrode was put in distilled water for 1 hour to remove triton X-100, and this cleaning process was repeated 3 to 4 times. Thereafter, until a predetermined cyclic voltammogram was obtained, the electrode was electrochemically cleaned in 1 M sulfuric acid solution by cycling potential between +0.68 to −0.72 V versus Hg/Hg₂SO₄. The surface area of the L₂-ePt electrode was determined from the hydrogen adsorption/desorption peaks of cyclic voltammogram (sweep rate, 200 mV/s) in 1 M sulfuric acid solution based on a conversion factor of 210 μC/cm². Poly-m-PD was electrochemically polymerized on the L₂-ePt cathode by cycling potential between +0.2 V and +1.0 V versus Ag/AgCl at 5 mV/s in 100 mM PBS containing 10 mM m-PD monomers. While repeated five times for L₂-ePt activation and selective diffusion of oxygen molecule to poly-m-PD membrane, cycling potential between −0.72 to +0.68 V was applied to the L₂-ePt cathode coated with poly-m-PD at 200 mV/s vs. Hg/Hg₂SO₄ in 1 M sulfuric acid solution.

### Example 3

### Constitution and Operation of Fuel Cell

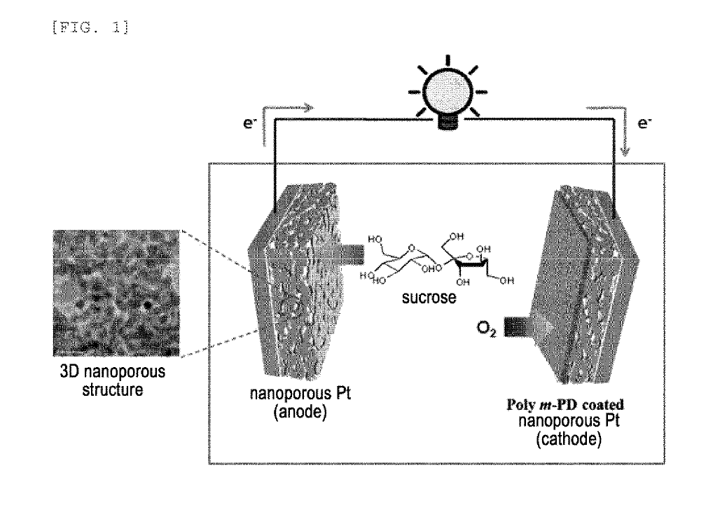

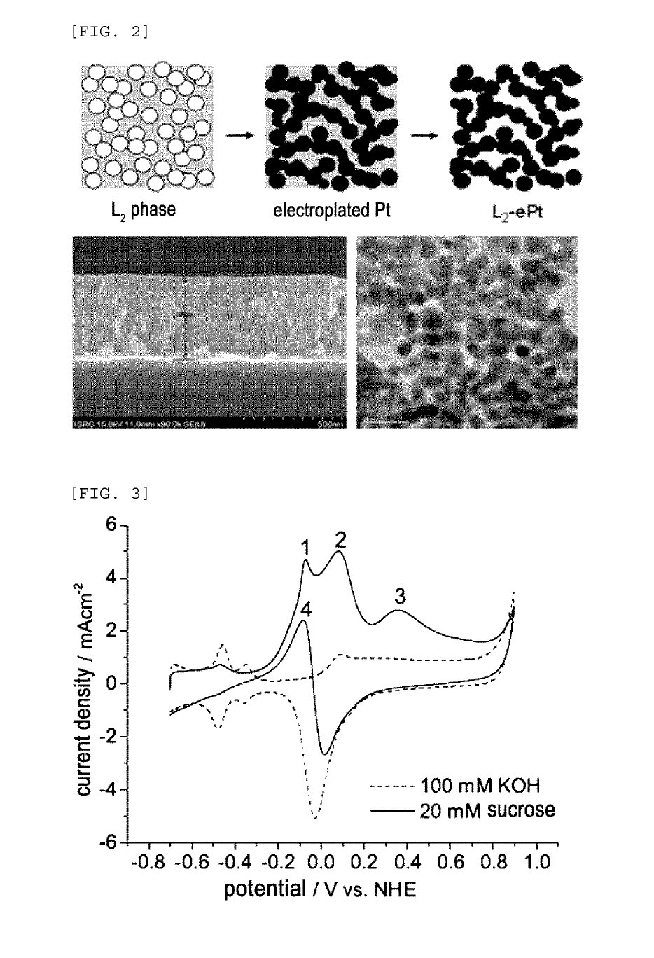

Untreated L₂-ePt and m-PD-modified L₂-ePt were used as an anode and a cathode, respectively (FIG. 1). Two electrodes were placed at a distance of 50 mm in a 20 mM KOH solution containing saccharides. The electrode potentials were measured in KOH solution containing various saccharides (sucrose, glucose, fructose, coke) as a fuel using variable resistance (FIG. 1). FIG. 2 is a schematic diagram showing a fabrication process of a nanoporous platinum electrode and a TEM image of the electrode fabricated.

### Example 4

### Measurement of Sucrose Electro-Oxidation Using Nanoporous Electrode

For electrolysis of sucrose, a potential step was applied a total of 3 times. The nanoporous electrode was reduced by applying −0.6 V versus Ag/AgCl electrode potential for 2 seconds. Then, a sucrose oxidation potential of −0.2 V was applied thereto for 13.8 seconds. Thereafter, oxidation potential of 0.75 V was applied for 0.2 second to regenerate the surface of the electrode. Such three potential steps were repeated for a desired time. The amount of charge flowing at the sucrose oxidation potential was examined to calculate the number of electrons per molecule of sucrose.

As a result, the residual amount of sucrose was measured by chromatography to confirm that up to 20 electrons were generated from one molecule of sucrose, which is 5 times higher than the use of a conventional flat platinum electrode, which produces up to 4 electrons by oxidation of sucrose (JOURNAL OF APPLIED ELECTROCHEMISTRY 27 (1997) 25-33). Thereby, it was confirmed that when the nanoporous structure is used, the reactant saccharide molecule continues to stay in the nanopore to increase the oxidation reaction.

### Experimental Results

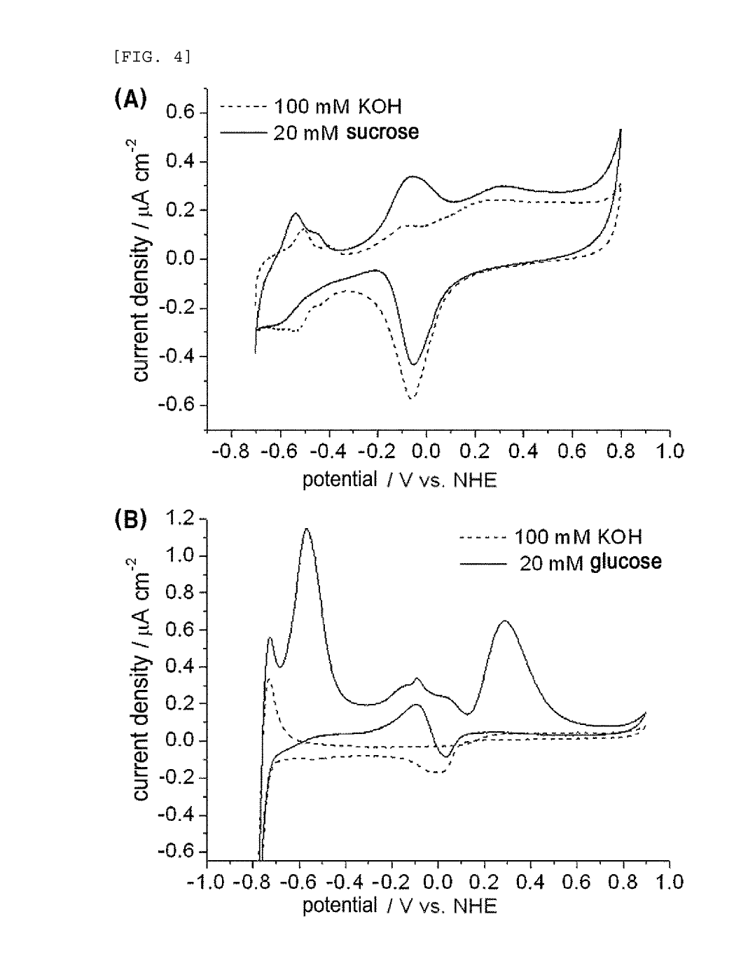

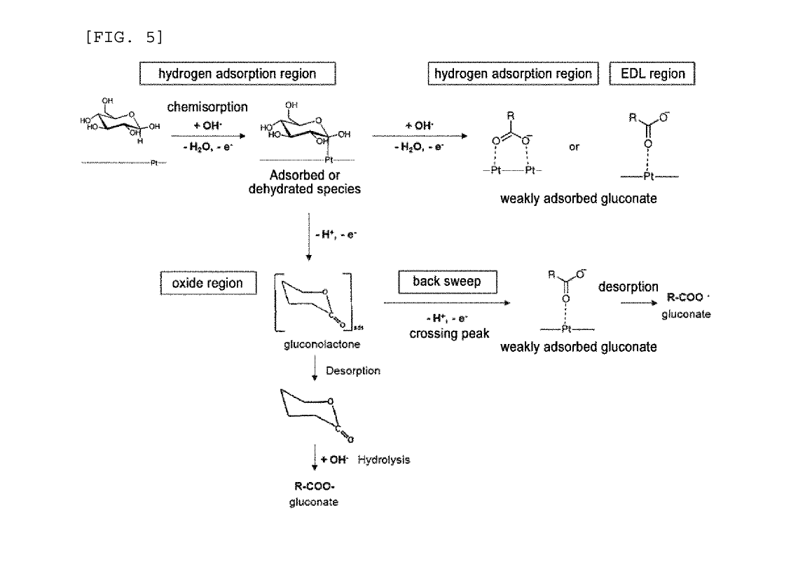

FIG. 3 shows electro-oxidation of sucrose in 100 mM KOH solution at L₂-ePt electrode. On a flat Pt electrode, glucose produced remarkably high electro-oxidation current, particularly, in the electric double layer (EDL), but oxidation current of sucrose was very low (FIG. 4). That is, the flat Pt electrode was sufficient for electro-oxidation of glucose, but had no electrical activity for sucrose oxidation. At the L₂-ePt electrode, the oxidation current of sucrose began to increase at −0.3 V, and sucrose oxidation showed three oxidation peaks at −0.1, 0.1 and 0.4 V with a positive potential sweep. Peak 1 was observed in the EDL region whereas Peak 2 was overlapped with the potential at which production of Pt oxide was begun. Meanwhile, Peak 3 appeared in the middle of the Pt oxide region (FIG. 3).

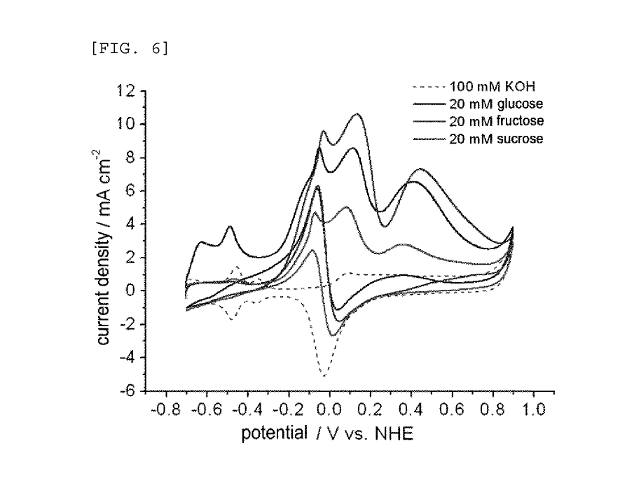

The mechanism of glucose electro-oxidation widely recognized is associated with the carbon atom C₁ which is a hemiacetal carbon involved in the primary reaction (FIG. 5). In the voltammogram obtained by using the same L₂-ePt electrode, the positions of the three oxidation peaks of sucrose were almost similar to those of glucose and fructose (FIG. 6), indicating that C₁ of the glucose moiety is also involved in sucrose oxidation. However, C1 of the glucose moiety is connected to C₅ of the fructose moiety in the sucrose form, and no reactive groups such as hydroxyl group exist therein. Therefore, it is considered that sucrose electro-oxidation on the surface of L₂-ePt is not the same as the mechanism of monosaccharides such as glucose.

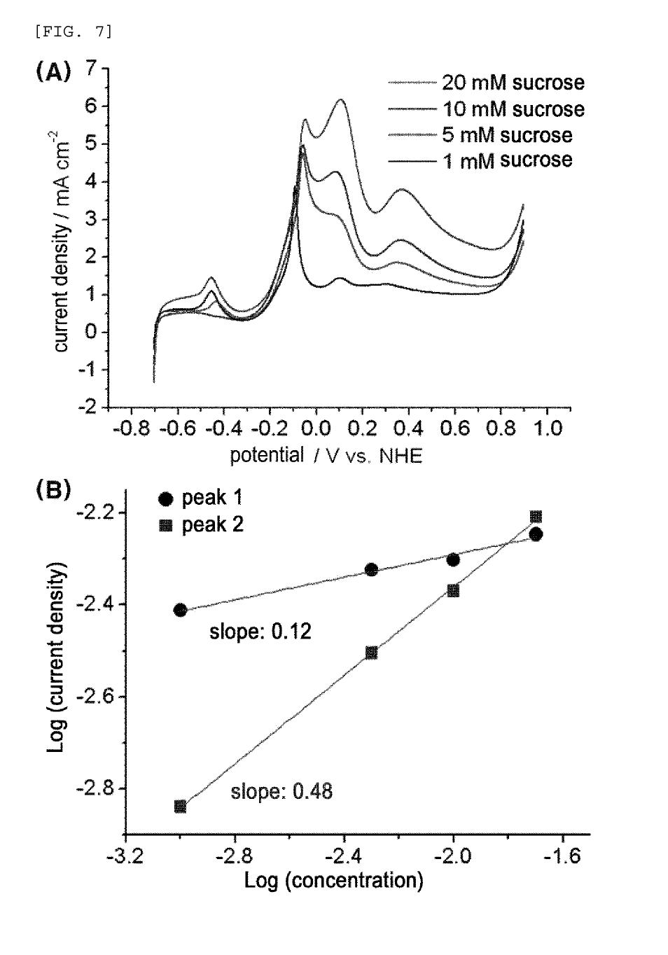

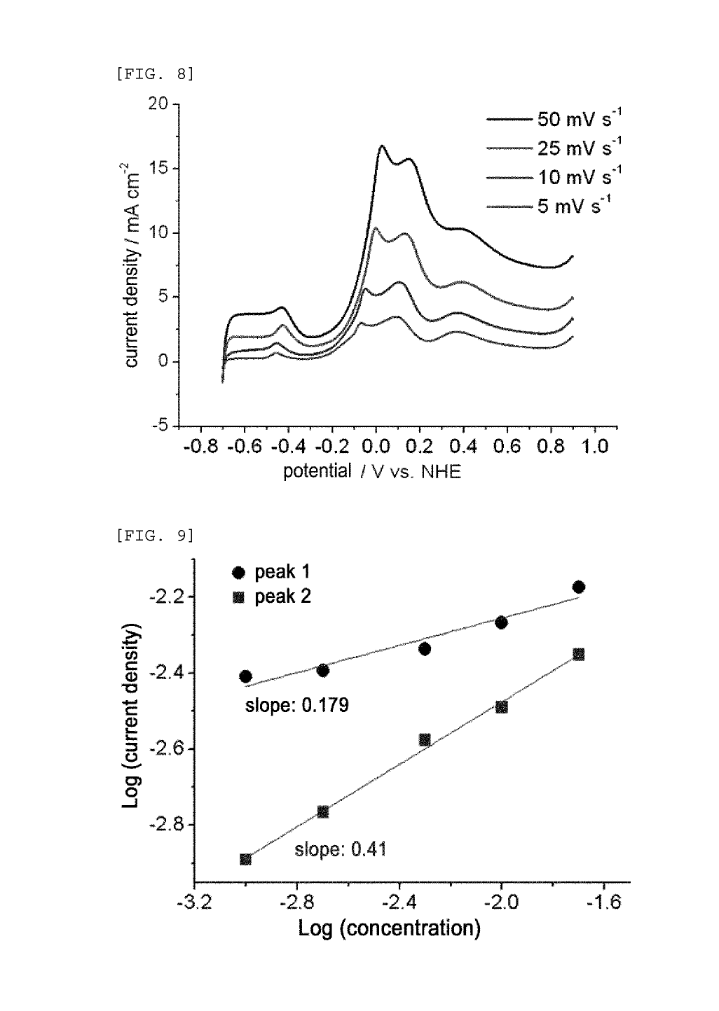

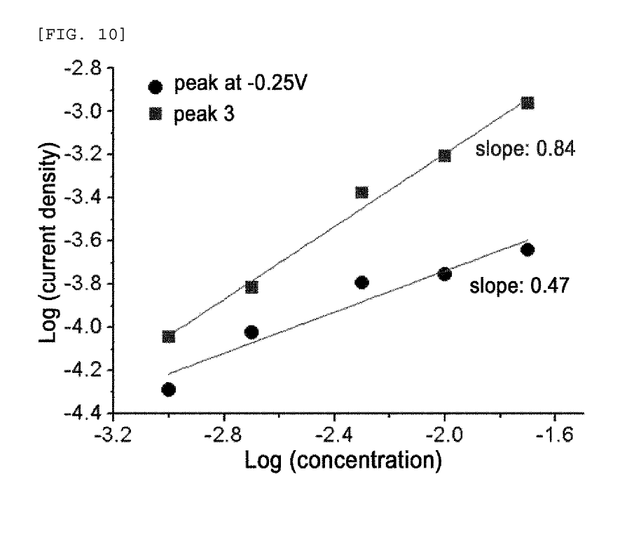

At low concentration (1 mM sucrose), Peak 1 of FIG. 7 was clearly symmetric, and remarkably larger than Peak 2 and Peak 3. As the sucrose concentration increased, Peak 2 and Peak 3 grew much faster than Peak 1 (FIG. 7A). In the plot of current density vs. concentration, the slope of Peak 1 (0.12 mA cm⁻² mM⁻¹) was much lower than those of Peak 2 and Peak 3 (FIG. 7B). Furthermore, the sweep rate dependence of Peak 1 was sharper than those of Peak 2 and Peak 3 (FIG. 8). Such behavior indicates that Peak 1 is attributed to oxidation of the sucrose molecule adsorbed onto the Pt surface. Meanwhile, Peak 2 and Peak 3 are associated with oxidation of the sucrose molecule approaching from a bulk solution by diffusion as well as the sucrose molecule adsorbed onto the surface. Similar voltammogram was observed in glucose (FIG. 9). The lower slope of Peak 1 than Peak 2 and Peak 3 was observed in both L₂-ePt and flat Pt. However, the slopes of these peaks in L₂-ePt were 2 times smaller than those of flat Pt (FIG. 10), indicating more remarkable contribution of the sucrose molecule adsorbed onto L₂-ePt. During the back sweep toward the negative direction, a large crossing wave (indicated by Peak 4 of FIG. 3) appeared. Transition of reduction current and oxidation current occurs at a particular potential at which Pt oxide production begins during the positive sweep. It can be explained by electroreduction of the Pt oxide layer that regenerates the metal Pt surface on which electro-oxidation of the sucrose molecule occurs.

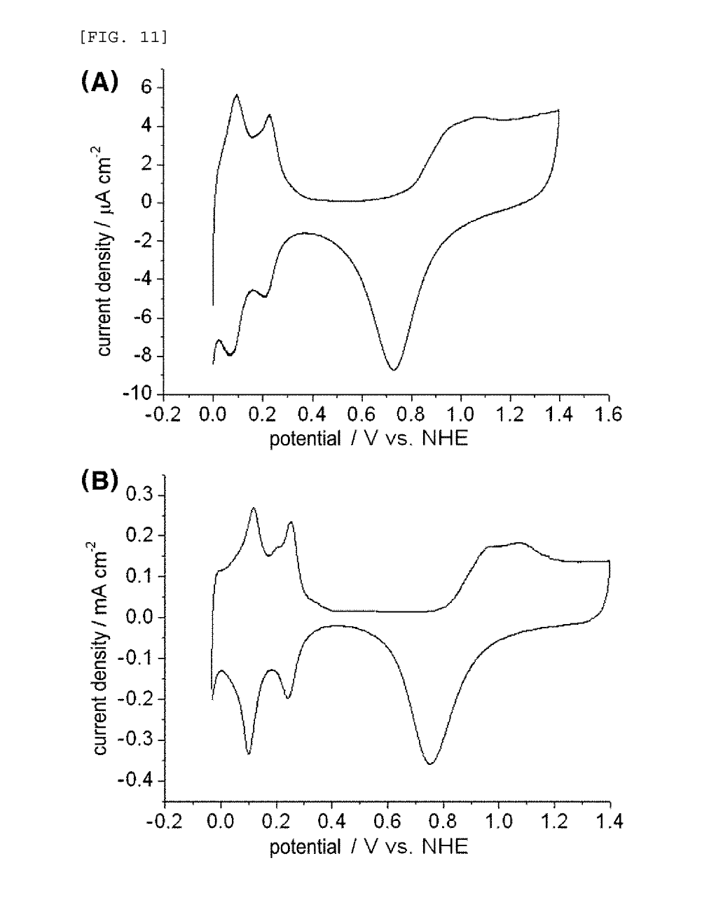

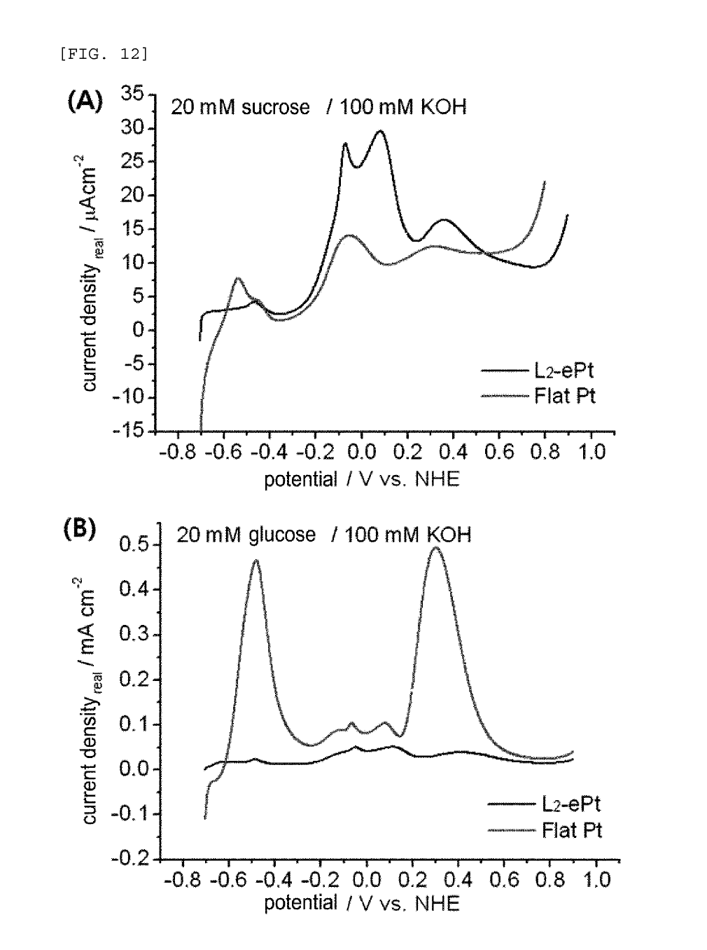

On the polycrystalline Pt surface, sucrose oxidation is slower than oxidation of glucose and fructose (FIG. 6), which is attributed to the prominent electrochemical properties of nanoporous Pt. Generally, electrokinetic improvement at porous electrodes involves effects of specific crystalline facets. However, the voltage current behavior in sulfuric acid solution in the hydrogen adsorption/desorption potential range showed that both flat Pt and L₂-ePt are polycrystalline platinum and indistinguishable in terms of the crystalline facet of their surface (FIG. 11). Therefore, the increased faradaic current on L₂-ePt can be explained by enlarged surface area. However, as in FIG. 12 showing the current density (jᵣₑₐₗ), which is the current divided by real surface area, instead of apparent surface area, the sucrose oxidation current at L₂-ePt was much higher than that at flat Pt at low overpotential (−0.1 to 0.2 V) (FIG. 12A), suggesting that a factor other than the enlarged surface area is also involved in electrokinetic improvement by L₂-ePt. The structural effect of the nanoporous electrode plays an important role in slow electrochemical reaction. The reactants surrounded by the nano-confined space remain around the electrode surface to induce much higher probability of electron transfer. Furthermore, molecular dynamics in nanopores causes highly frequent interaction between the molecule and electrode surface. Therefore, slow kinetics of sucrose oxidation can be promoted by the confined molecular dynamics in nanopores as well as the enlarged surface area, and remarkable sucrose electrocatalytic oxidation can be induced, compared to the previous results by L₂-ePt. Meanwhile, glucose oxidation on L₂-ePt produced much lower current density than that on flat Pt at the entire potential (FIG. 12B). Because a glucose molecule is oxidized fast, the portion deep inside the electrode surface of nanoporous platinum does not participate in electro-oxidation, and the increased faradaic current is only attributed to the enlarged surface area.

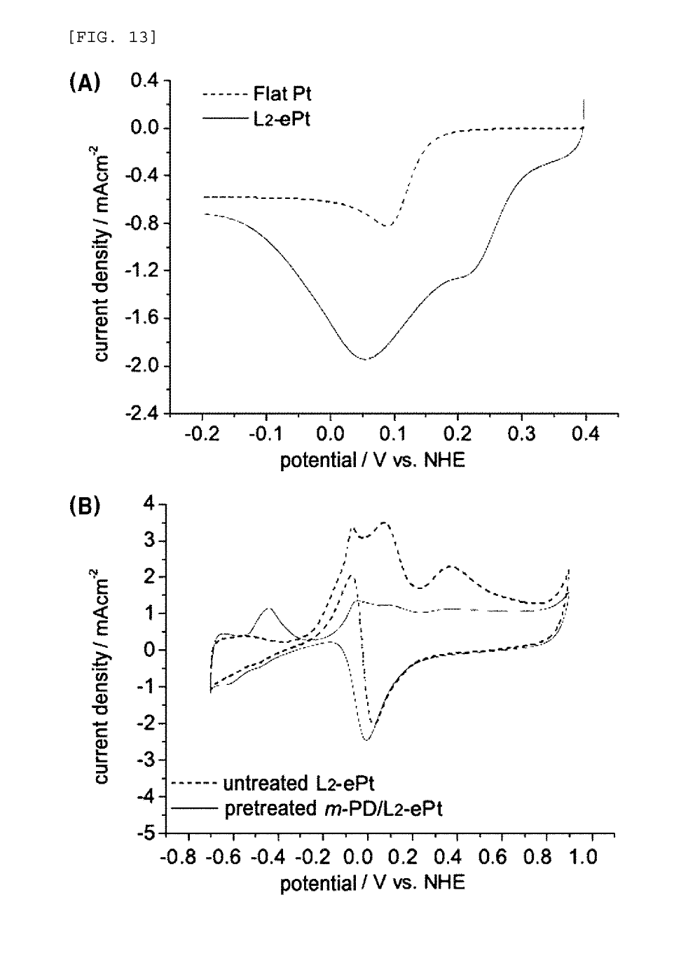

The thermodynamic potential for oxygen reduction reaction (ORR) in an alkaline medium vs. NHE (sodium-hydrogen exchanger) was 0.401 V. As shown in FIG. 11, oxygen reduction on flat Pt was generated at about 150 mV. In contrast, the starting potential of ORR on L₂-ePt was earlier than that of the flat Pt and was about 150 mV closer to the thermodynamic potential, suggesting that a platform for a sucrose-air fuel cell capable of producing a higher cell potential can be provided by use of L₂-ePt. Two reduction peaks appeared around 0.22 V and 0.05 V. The peak at 0.22 V was due to pure ORR current and the other peak at 0.05 V was due to ORR current and Pt oxide reduction current. These peaks were identified by comparison with voltammogram obtained in an oxygen-free KOH solution (FIG. 13).

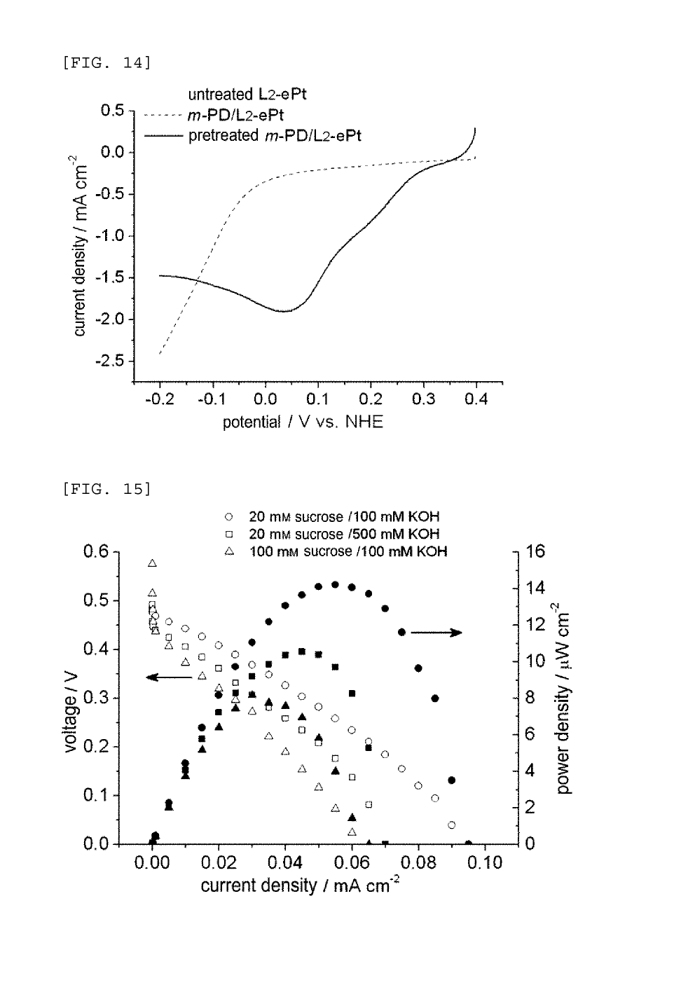

In a closed cell circuit, sucrose diffusion toward the cathode should be minimized in order to mainly induce ORR. To fabricate the cathode, poly-m-PD (m-phenylenediamine) was electrochemically polymerized on L₂-ePt to completely block sucrose oxidation and ORR. Potential cycling in the sulfuric acid solution loosens the compact poly-m-PD to allow selective diffusion of oxygen molecules (FIG. 14). The effect of electrochemical treatment was confirmed by observing lightening of the dark brown poly-m-PD membrane with increasing cycling frequency. During 5 repetitions of potential sweep cycling, optimal conditions could be found, under which a starting potential of ORR was almost recovered to the value on untreated L₂-ePt (FIG. 14) whereas three main peaks of sucrose oxidation disappeared (FIG. 12). Consequently, L2-ePt on which poly-m-PD is electrochemically treated substantially inhibits fuel crossover to the electrode and can be used as a cathode where oxygen reduction reaction occurs. By combining it with untreated L₂-ePt, it is possible to achieve a new compartmentless carbohydrate fuel cell (FIG. 15).

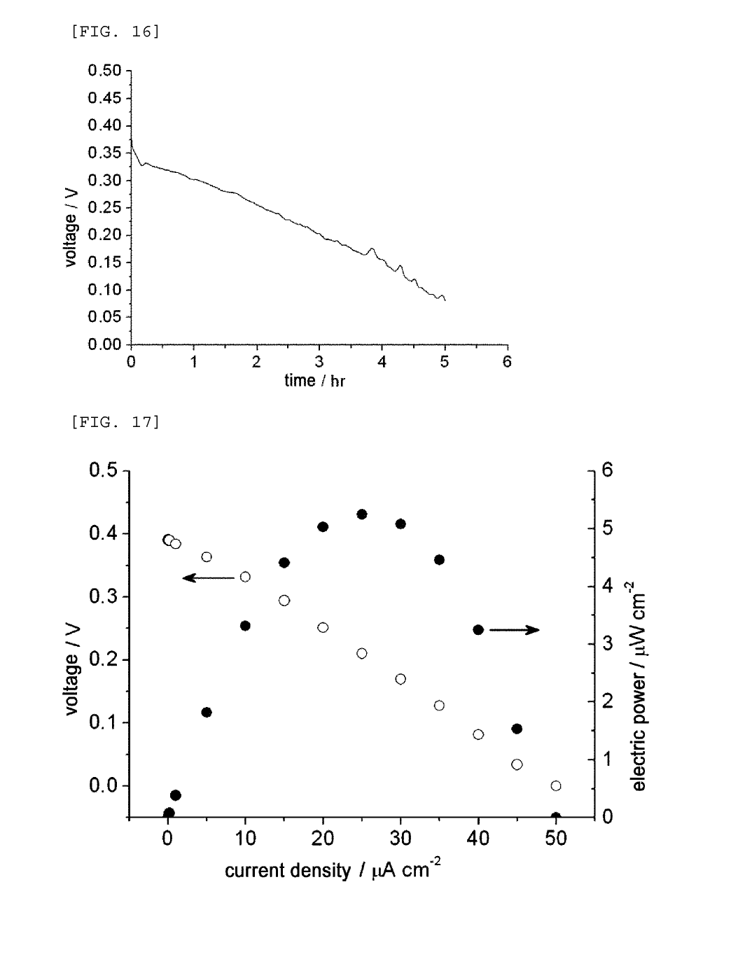

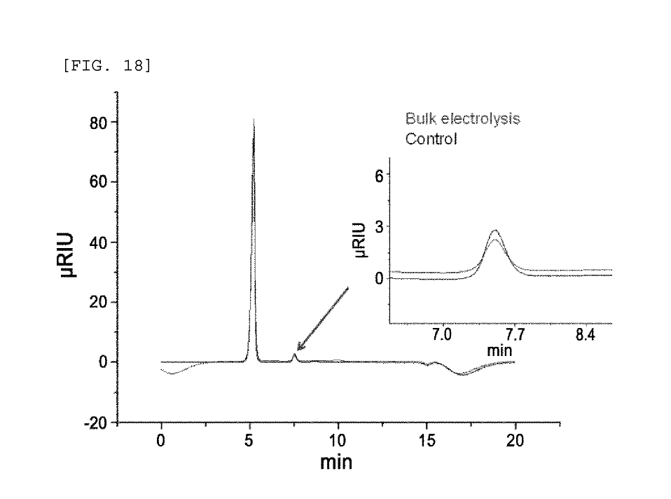

The potential of the fuel cell using untreated L₂-ePt as the anode and poly-m-PD-coated L₂-ePt as the cathode was measured by varying sucrose concentration (FIG. 15). An open circuit potential (Voc) for 20 mM sucrose/100 mM KOH solution at 0.25 V was 0.48 V, and the maximum power density (Wmax) was 14 μW/cm², which was comparable to those of mediator-, cofactor-free glucose biofuel cells. Output power was reduced in sucrose and KOH solution at higher concentrations. Under the conditions, more sucrose molecules were electrooxidized, but ORR interference by sucrose becomes more serious. Furthermore, it must be considered that the kinetics of ORR in a strong alkaline medium is much slower. The long-term stability of the abiotic sucrose-air fuel cell was also examined (FIG. 16). The half potential of Voc at 5 μW/cm² was maintained at 0.2 V for 3 hours (FIG. 17).

To examine the practical usefulness of the abiotic carbohydrate-fuel cell proposed in the present invention, coke, which is a very common source of the sugar supply to be widely used as a fuel for the production of electricity, was used. Coke contains 22 g of sugar in 200 ml solution, which corresponds to approximately 0.6 M concentration. FIG. 17 shows voltage and power density of 1/10-diluted coke in 100 mM KOH solution which was plotted as a function of current density. Voc was 0.4 V and Wₘₐₓ of 5 μW/cm² was measured at 25 μA/cm². The performances of the abiotic fuel cell proposed in the present invention were not better than those of the previously reported enzymatic biofuel cells using coke. Nevertheless, the proposed system can provide a valuable opportunity for an abiotic fuel cell. Its operating conditions are extraordinarily simple, compared to enzyme or other biological factor-dependent biofuel cells. Therefore, a plurality of electrodes is compactly arranged on a small portable device by a micromachining process to produce much higher electricity. Moreover, such type of abiotic fuel cell offers a possibility of environmentally-friendly fuel cell power device without using toxic materials such as oxidation/reduction mediators.

### Effect of the Invention

In a fuel electrode including a nanoporous platinum layer of the present invention, fuel molecules pass through the pores of the surface to reach inside the catalyst layer and experience highly frequent interactions with catalysts by the confined molecular dynamics, and they react in contact with the surface of the catalyst to oxidize hydrocarbons (e.g., sucrose which is a disaccharide) having an alcohol group with a relatively high oxidation potential unaided by enzymes, thereby generating electrons. Meanwhile, the fuel cell including a nonconductive polymer membrane-coated oxygen electrode on the nanoporous platinum layer blocks access of fuel molecules by size exclusion and permits selective diffusion of oxygen molecule to allow reaction with the catalyst layer, thereby exhibiting fuel cell activity with no crossover of fuel molecules without using an electrolyte membrane provided in the typical fuel cell. Accordingly, the fuel cell including the fuel electrode and the oxidation electrode of the present invention is able to use polysaccharides and hydrocarbons having alcohol groups with high molecular weight as well as monosaccharides as a fuel unaided by enzymes. Further, it is not necessary to separate the fuel electrode and the oxidation electrode from each other in additional compartments using an electrolyte membrane, as long as they are electrically separated; thereby making its miniaturization possible, thereby increasing its applications as a portable fuel cell. Further, energy can be produced by direct oxidation of saccharides produced in an artificial photosynthetic system, and a hybrid system combined with the artificial photosynthetic-saccharide air fuel cell can also be expected. The fuel cell utilizes a variety of readily available hydrocarbons as fuels and thus it can be used as a power system for portable military devices.

What is claimed is:

1. A fuel electrode comprising a substrate and a nanoporous metallic catalyst layer thereon, wherein the metallic catalyst layer includes open interconnected 3D nanopores, and the pores and the pore connections therebetween have a size suitable for allowing hydrocarbons having alcohol groups to pass through the interconnected pores so that they react in contact with the surface of the catalyst by confined molecular dynamics.

2. The fuel electrode according to claim 1, wherein the pores and the pore connections of the nanoporous metallic catalyst have a cross-sectional diameter of 1 to 3 nm.

3. The fuel electrode according to claim 1, wherein the substrate is selected from the group consisting of a gold or platinum-plated silicon wafer, a gold or platinum-plated glass slide, a gold or platinum-sputtered polyimide film, and an ITO electrode.

4. The fuel electrode according to claim 1, wherein the metallic catalyst is selected from the group consisting of platinum, palladium, ruthenium, porous carbon, and non-noble metal.

5. The fuel electrode according to claim 1, wherein the hydrocarbons having alcohol groups are saccharides.

6. The fuel electrode according to claim 5, wherein the saccharides are monosaccharides, disaccharides, or polysaccharides.

7. The fuel electrode according to claim 5, wherein the saccharides are produced naturally or via an artificial photosynthetic system.

8. The fuel electrode according to claim 1, wherein the hydrocarbon having an alcohol group passes through the pore of the nanoporous metallic catalyst layer of the fuel electrode, and the hydrocarbon reacts in contact with the surface of the catalyst to provide electrons by oxidation.

9. A compartmentless fuel cell electrode pair comprising the fuel electrode of claim 1; and a polymer membrane-coated oxygen electrode into which a catalyst layer is introduced onto a substrate and wherein the polymer membrane blocks hydrocarbons having alcohol groups as a fuel molecule and permits the diffusion of oxygen molecules.

10. The electrode pair according to claim 9, wherein the polymer membrane is made of a material selected from the group consisting of poly m-phenylenediamine and polyphenol.

11. The electrode pair according to claim 9, wherein the catalyst layer is selected from the group consisting of platinum, palladium, and ruthenium, porous carbon, and non-noble metal.

12. The electrode pair according to claim 9, wherein the catalyst layer is a nanoporous platinum layer.

13. The electrode pair according to claim 9, wherein the fuel cell electrode pair is provided in an electrically separated form by arranging the fuel electrode and the oxygen electrode at a distance from each other, or by placing a non-conducting thin spacer between the substrate sides of both electrodes to form an assembly.

14. An abiotic saccharide-air fuel cell comprising the fuel electrode of claim 1, an oxygen electrode to which a polymer membrane is applied, and a container capable of containing hydrocarbons having alcohol groups, wherein the fuel cell utilizes the hydrocarbons having alcohol groups as a fuel.

15. The fuel cell according to claim 14, wherein the polymer membrane blocks hydrocarbons having alcohol groups as the fuel molecule and permits diffusion of oxygen molecules.

16. The fuel cell according to claim 15, wherein the polymer membrane is made of a material selected from the group consisting of poly m-phenylenediamine and polyphenol.

17. The electrode pair according to claim 9, wherein the pores and the pore connections of the nanoporous metallic catalyst in the fuel electrode have a cross-sectional diameter of 1 to 3 nm.

18. The electrode pair according to claim 9, wherein the hydrocarbon having an alcohol group passes through the pore of the nanoporous metallic catalyst layer of the fuel electrode, and the hydrocarbon reacts in contact with the surface of the catalyst to provide electrons by oxidation.

19. The fuel cell according to claim 14, wherein the pores and the pore connections of the nanoporous metallic catalyst in the fuel electrode have a cross-sectional diameter of 1 to 3 nm.

20. The fuel cell according to claim 14, wherein the catalyst layer in the fuel electrode is selected from the group consisting of platinum, palladium, and ruthenium, porous carbon, and non-noble metal.
